(19) United States
(12) Patent Application Publication
(10) Pub. No.: US 2009/0142042 A1
(43) Pub. Date: Jun. 4, 2009

(54) SYSTEMS, METHODS, AND COMPUTER PRODUCTS FOR A CUSTOMIZED REMOTE RECORDING INTERFACE

(75) Inventor: Michael BRANAM, Lawrenceville, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 12/170,370

(22) Filed: Jul. 9, 2008

Related U.S. Application Data
(63) Continuation of application No. 11/948,736, filed on Nov. 30, 2007, now abandoned.

(51) Int. Cl. H04N 7/26

(52) U.S. Cl. 386/124; 386/E05.001

(57) ABSTRACT

Systems, methods and computer products for a user interface for remote DVR management and scheduling are provided. Exemplary embodiments include, a remote device method for managing a DVR, the method including retrieving a set of menu entries for the menu, each of the menu entries representing a digital video recorder function, displaying the set of menu entries on the display, receiving a menu entry selection signal indicative of the selection device pointing at a selected menu entry from the set of menu entries and performing an associated digital video recorder function.

### CROSS-REFERENCE TO RELATED APPLICATION

This application is a continuation of U.S. patent application Ser. No. 11/948,736 filed Nov. 30, 2007, the disclosure of which is incorporated by reference herein in its entirety. The co-pending application is assigned to the same assignee as this application, AT&T Delaware Intellectual Property, Inc. of Wilmington, Del.

### BACKGROUND

Exemplary embodiments relate generally to Internet Protocol Television (IPTV) and digital (personal) video recorders (DVR), and more particularly, to systems, methods and computer products for a user remote interface for DVR management and scheduling.

Internet protocol television (IPTV) is a digital television delivery service wherein the digital television signal is delivered to residential users via a computer network infrastructure using the Internet Protocol. Typically, IPTV services are bundled with additional Internet services such as Internet web access and voice over Internet protocol (VOIP). Subscribers receive IPTV services via a set-top box that is connected to a television or display device for the reception of a digital signal. Used in conjunction with an IP-based platform, the set-top box allows for a subscriber to access IPTV services and any additional services that are integrated within the IPTV service. In addition, DVRs can be coupled to the IPTV-enabled devices in order to record the content available from IPTV.

IPTV service platforms allow for an increase in the interactive services that can be provided to residential subscriber. As such, a subscriber can have access to a wide variety of content that is available via the IPTV service or the Internet. For example, a subscriber may utilize interactive services via a set top box to view IPTV content or access their personal electronic messaging accounts via an Internet web browser. The IPTV infrastructure also allows the delivery of a variety of video content instantly to the subscribers. Such content can be recorded on the subscriber's DVR.

Current DVR capability enables a subscriber to search for programs via an electronic programming guide (EPG) and to schedule recordings based on current and future programming, typically two weeks into the future. However, subscribers are given very little DVR management and scheduling capability with respect options in handling DVR recording schedules. For example, currently there lacks a remote DVR interface for management of scheduling.

### BRIEF SUMMARY

Exemplary embodiments include, a remote device method for managing a DVR, the method including retrieving a set of menu entries for the menu, each of the menu entries representing a digital video recorder function, displaying the set of menu entries on the display, receiving a menu entry selection signal indicative of the selection device pointing at a selected menu entry from the set of menu entries and performing an associated digital video recorder function.

Additional exemplary embodiments include a remote DVR management system, including a digital video recorder coupled to an Internet Protocol-enabled device and in communication with a remote device, a process for displaying digital video recorder options on the remote device, the process having instructions to retrieve a set of menu entries for a menu on the display, each of the menu entries representing a digital video recorder function, display the set of menu entries on the display, receive a menu entry selection signal indicative of the selection device pointing at a selected menu entry from the set of menu entries and perform an associated digital video recorder function.

Further exemplary embodiments include a computer program product for displaying digital video recorder options on a remote device coupled to an Internet Protocol-enabled device, the remote device having a graphical user interface including a display and a selection device, the computer program product including instructions for causing a computer to implement a method, the method including retrieving a set of menu entries for the menu, each of the menu entries representing a digital video recorder function, displaying the set of menu entries on the display, receiving a menu entry selection signal indicative of the selection device pointing at a selected menu entry from the set of menu entries and performing an associated digital video recorder function.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram of an exemplary DVR management and scheduling system;

FIG. 2 illustrates a screen shot of an exemplary DVR search user interface;

FIG. 3 illustrates another screen shot of a DVR search user interface in accordance with exemplary embodiments;

FIG. 4 illustrates a screen shot of a DVR schedule user interface in accordance with exemplary embodiments;

FIG. 5 illustrates a screen shot of a DVR recordings user interface in accordance with exemplary embodiments; and

FIG. 6 illustrates a flow chart of a remote DVR management and scheduling method in accordance with exemplary embodiments.

The detailed description explains the exemplary embodiments, together with advantages and features, by way of example with reference to the drawings.

### DETAILED DESCRIPTION OF EXEMPLARY EMBODIMENTS

Exemplary embodiments include systems, methods and computer products for DVR management and scheduling. In exemplary embodiments, a system is provided that includes remote DVR management and scheduling services including, but not limited to: recorded and viewed programs indication; cancellation options for recorded and viewed programs; deletion priority for recorded and viewed programs; schedule change conflict resolution; DVR scheduling; remote and local DVR interface management; DVR searching and programming; multi-level DVR content searching, search saving and favorite channel management; and DVR management alerts and notifications.

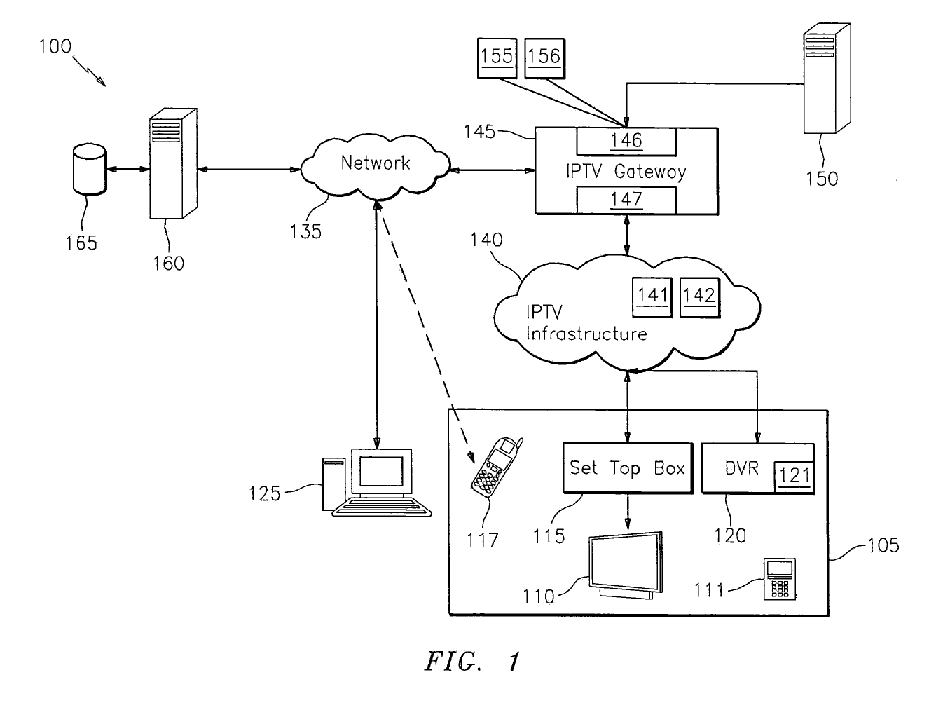

Turning now to FIG. 1, a block diagram of an exemplary remote DVR management and scheduling system 100 is now described. For ease of illustration, the system 100 of FIG. 1 depicts a simplified network infrastructure. In addition, for ease of illustration, the system 100 is described implementing an Internet Protocol Television (IPTV) system for reception of programming and scheduling. It is understood that the systems and methods described herein can implement television and program-viewing systems other than IPTV. For example, the system 100 can implement cable, satellite and antenna.

Furthermore, it is understood that a variety of network components/nodes may be utilized in implementing the embodiment described herein. For example, in exemplary embodiments, the system 100 includes a means for accessing network services for multiple disparate devices using a single sign on procedure. Therefore, the system 100 manages accounts, each of which is established for a community of devices and/or device subscribers, such as those devices and subscribers in a subscriber location 105, which may include a communications device 110 (e.g., an IPTV-enabled television) coupled to a set top box 115. Where the communications device 110 is IPTV, the set top box 115 includes a processor that provides bidirectional communications between the IPTV infrastructure 140 and the communications device 110 and decodes the video streaming media received as content programming and onscreen programming information, from a content services provider server 160, discussed further below. Other services can be provided to the subscriber location, such as, but not limited to phone services, network services and other exemplary services such as the remote DVR management and scheduling services that can be implemented via the communications device 110. The accounts may thus include phone, network access and IPTV services and may be used to provide access to the remote DVR management and scheduling services as described further herein. Furthermore, in exemplary embodiments, one of the devices (e.g., the communications device 110) can be provisioned for the network services described herein by associating a device identifier of the communications device with a respective account. The account, in turn, identifies each of the communications devices belonging to the community and provides other information as described herein. Furthermore, it is appreciated that other devices such as a subscriber computer 125 can be further included in the community of devices established for the subscriber location 105. It is appreciated that the subscriber computer 125 can be local to the subscriber location 105 or can represent any other remote computer that can be used to access the services described herein. It is further appreciated that other remote devices can be implemented to access the services described herein such as but not limited to a cellular telephone (e.g., a 3G cell phone), a personal computer, a laptop computer, a portable computing device (e.g., personal digital assistant), and a digital music player (e.g., MP3 player), collectively represented as device 117. As discussed further herein, a remote DVR management and scheduling services interface can be rendered on any of the above-referenced devices to implement the DVR management and scheduling services in accordance with exemplary embodiments. It is appreciated that the remote DVR management and scheduling services described herein are implemented on a remote device such as device 117.

In exemplary embodiments, one of the devices, such as the communications device 110 (and the set top box 115, in combination) can be used to establish account services, such as the remote DVR management and scheduling services described herein. An account record may be generated for the subscriber at the subscriber location 105, which identifies the subscriber and the account for which the services (e.g., basic account services as described above and the remote DVR management and scheduling services described herein). Account information and records may be stored in a storage device accessible by an IPTV gateway 145, discussed below. In exemplary embodiments, the IPTV gateway 145 implements one or more applications for establishing and utilizing access the remote DVR management and scheduling services account. Access to the remote DVR management and scheduling services account may thus be created for a community of communications devices (e.g., the communications device 110) to enable the communications devices to implement the remote DVR management and scheduling services as described herein. A preferences server 150, which is coupled to the IPTV gateway 145, includes preferences information for the subscriber location 105 as described further herein.

As discussed above, the system 100 of FIG. 1 includes the subscriber location 105, such as the subscriber's household. The subscriber location 105 can include the communications device 110 (e.g., an IPTV-enabled television) in communication with the set top box 115. The subscriber location 105 can further include a personal digital recorder such as a DVR 120, which is in communication with the communication device 110 and the set top box 115. It is understood that the set top box 115 and the DVR 120 may be two separate devices or be a single integrated device. In exemplary embodiments, the DVR 120 is hard-disk based, but may have other suitable storage media such as a cache, 121. It is appreciated that the DVR 120 can have other suitable memory devices for receiving and storing programming and scheduling data. Therefore, a “memory” or “recording medium” can be any means that contains, stores, communicates, propagates, or transports the program and/or data for use by or in conjunction with an instruction execution system, apparatus or device. The memory and the recording medium can be, but are not limited to, an electronic, magnetic, optical, electromagnetic, infrared or semiconductor system, apparatus or device. The memory and recording medium also include, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored. It is appreciated that the DVR 120 may be local on the set top box 115 (as described), or networked, or on an allocated media server storage space.

The subscriber location 105 can further include a remote control 111 for control and navigation of the communications device 110. As further described herein the remote control 111 can be implemented to navigate a DVR management and scheduling services interface that is similar to the remote DVE management and scheduling service interface described herein. As discussed above, the subscriber location 105 can further include one or more remote devices in its community of devices. For example, the remote devices can include the remote subscriber computer 125. In exemplary embodiments, the remote subscriber computer 125 can be part of the subscriber location 105, or a computer that is accessed remotely in order to access the DVR management and scheduling services for control, management and scheduling of video content (e.g., content for recording on the DVR 120) from the content services provider server 160 to the subscriber location 105 for rendering on the communications device 110. It is therefore appreciated that access to the remote DVR management and scheduling services can be managed from a location remote to the subscriber location 105. In exemplary embodiments, the access to the remote DVR management and scheduling services is implemented via a remote device such as the device 117 but can also be accessed by any remote device such as the computer 125. It is understood by those skilled in the art that the remote subscriber computer 125 can include input and output devices, such as but not limited to a display, a mouse and a keyboard. Other devices that can access the DVR management and scheduling services include the device 117. As discussed further below, the aforementioned devices can all interact with an IPTV infrastructure 140 and the IPTV gateway 145. It is appreciated that any of the aforementioned devices can implement the remote DVR management and scheduling services. In exemplary embodiments, the communications devices herein can have a network address associated with the communications devices such as an addressable uniform resource locator (URL), and an Internet address.

The system 100 can implement the remote DVR management and scheduling services such that desired DVR control, management and scheduling can be managed and viewed through the subscriber's IPTV-enabled device, such as the communications device 110, via set top box 115, the remote devices (e.g., the remote subscriber computer 125, and the device 117) or other suitable device. As such, to coordinate IPTV communication, the system 100 may further include the IPTV gateway 145 that is in communication with the IPTV infrastructure 140. The IPTV infrastructure 140 and the IPTV gateway 145 are used in conjunction to communicate via the network 135. For example, a suitable device (e.g., the communications device 110, the device 117, and the remote subscriber computer 125.) at the subscriber location 105 can implement the IPTV infrastructure 140 and the IPTV gateway 145 to communicate with the content services provider server 160 to access data from databases such as a database 165 (described further herein).

The network 135 can be an IP-based network for communication between the content services provider server 160 and the subscriber location 105 using communication devices such as but not limited to the communications device 110 (via the set top box 115, for example). The network 135 can be implemented to transmit content from the content services provider server 160 to the subscriber location 105 via a broadband connection, for example. In exemplary embodiments, the network 135 can be a managed IP network administered by a service provider. The network 135 can also be implemented in a wireless fashion, e.g., using wireless protocols and technologies, such as Wi-Fi, Wi-Max, etc. The network 135 can also be a cellular communications network, a fixed wireless network, a wireless local area network (LAN), a wireless wide area network (WAN), a personal area network (PAN), intranet, metropolitan area network, Internet network, or other similar type of network environment or other suitable network system and includes equipment for receiving and transmitting signals. In other exemplary embodiments, the network 135 can be a circuit-switched network such as a standard public switched telephone network (PSTN).

In exemplary embodiments, the IPTV infrastructure 140 can be an IP-based network that receives network data (e.g., programming content for recording on the DVR) from the content services provider server 160 and the preferences server 150, and delivers the network data to the set top box 115 for display or other rendering on the communications device 110. Alternatively, the network data can be for display or rendering on the remote subscriber computer 125 or other suitable device, such as device 117.

In exemplary embodiments, as discussed above, the IPTV infrastructure 140 provides an interface between the subscriber location 105 and the IPTV gateway 145. In exemplary implementations, a notification server 141 and a terminal server 142 operate to interface communication between the subscriber location 105 via the set top box 115, and the IPTV gateway 145. For example, in exemplary implementations, the set top box 115 can provide a unique identification number so that the IPTV gateway 145 can route the network data to the set top box 115. In doing so, a message is passed between the notification server 141 and the set top box 115. Furthermore, the IPTV gateway 145 provides an interface between the content services provider server 160, and the IPTV infrastructure 140 and subscriber location 105. In exemplary embodiments, the IPTV gateway 145 handles notifications to the IPTV subscriber location 105 and can further provide a history of the notifications. A remote DVR management and scheduling services application 155 can reside partially or wholly on the IPTV gateway to handle the notifications as further described herein. In exemplary embodiments, the remote DVR management and scheduling services application 155 can further reside partially or wholly on the set top box 115. When the subscriber sets up his/her DVR management and scheduling services on the communications device 110 (or other device in the subscriber location 105, remote device, such as the subscriber computer 125 and device 117), one of the network components of the system 100 (e.g., the set top box 115, or the IPTV gateway 145.) can store specific scheduling information that the subscriber has created. For example, as discussed further herein, each subscriber can access and manipulate viewing and recording information for the DVR 120 via an interface. As such, if the interface is stored on the IPTV gateway 145, messages and notifications can be passed between the subscriber location 105 and the IPTV gateway 145 that include present scheduling and historic scheduling that the subscriber has created in the past. Furthermore, if any changes in the subscribers scheduled recordings have occurred, messages can be passed to the subscriber location 105 (or remote device) to notify the subscriber that a program scheduled to be recorded on the DVR 120 has changed. The subscriber can make changes accordingly. It is appreciated that the remote DVR management and scheduling services application can further reside wholly or partially on the corresponding remote device such as the remote device 117.

In exemplary embodiments, the IPTV gateway 145 can further interface with the various system 100 elements as described herein. For example, the IPTV gateway 145 is in communication with the preferences server 150 to pass notifications and messages (e.g., Email messages) regarding permissions to create and edit remote DVR management and scheduling information. For example, different members of the subscriber location 105 who share account services may have different recording schedules. For example, one member may have a first unique recording schedule and another member may have a second unique recording schedule with little to no overlap with the first recording schedule. As such, each member can retrieve and edit those different schedules and be properly authenticated to retrieve and edit those schedules.

In exemplary embodiments, the IPTV gateway 145 can include a back end 146 and a front end 147. The front end 147 can be used to implement various provisioning activities such as but not limited to initial provisioning of IPTV addresses for the devices at subscriber location 105. The back end 146 can be implemented for many of the DVR management and scheduling services, such as communicating with the content services provider server 160 and retrieving scheduling and programming data from the database 165, and passing messages and notifications to the IPTV gateway 145. As such, the back end 146 can include various elements including but not limited to a caller ID handler, SMS handler, message handler, and provisioning handler.

In exemplary embodiments messages and notification can be sent between the IPTV gateway 145 and the subscriber location 105. In exemplary embodiments, the message and notifications can be implemented via an email message. In exemplary embodiments, the IPTV gateway 145 is responsible for retrieving email messages that have been sent to an IPTV subscriber and providing notification of the reception of the email message to the IPTV subscriber at the subscriber location 105. A notification can be in the form a “pop-up” display window displayed at a suitable device (e.g., the communications device 110) or any other conventional message notification scheme. As discussed above, the IPTV gateway 145 can present a history of the notifications to the IPTV subscriber. It is appreciated that the messages described herein can be accordingly routed to the remote device 117 for the remote DVR management and scheduling services described herein.

In exemplary embodiments, the IPTV gateway 145 interfaces with a POP3 infrastructure in order to retrieve email messages that have been directed to an IPTV subscriber. Additionally, the IPTV gateway 145 can interface with the preferences server 150. As described herein, the preferences server 150 is responsible for handling the performance preferences for the system 100 as dictated by the desires of an IPTV subscriber. Further, the IPTV gateway 145 is responsible for retrieving an IPTV subscriber's preferences for the set top box 115, and preferences set up on the remote device 117.

In exemplary embodiments, the IPTV gateway 145 interacts with the IPTV infrastructure 140 to accomplish the actual transmittal of the email message to the set top box 115. Further, all email notifications that are generated within the system 100 are saved to a log at the IPTV gateway 145. In exemplary embodiments, the subscriber can view a listing of the received email message log on their display device via an application that runs on the set top box 115.

In exemplary embodiments, the front end 147 can include a message center application that in communication with a message center enterprise java bean (EJB) and an email handler that are included within the back-end 146. The IPTV infrastructure 140 is provisioned with the subscriber user account numbers and set top box 115 identifiers. In exemplary embodiments, the IPTV gateway 145 includes a telephone number-to-account number mapping component, wherein a provisioned telephone number correlates to the IPTV subscriber's primary household telephone number (e.g., to the device 117). The IPTV subscriber's telephone number is further associated with the IPTV subscriber's email address. Further, the telephone number and email address are linked with the subscriber's IPTV account number through a web-provisioning interface that is available within the IPTV gateway 145. The IPTV gateway 145 has the ability to retrieve email messages and any image or audio/video attachments to the message, wherein the messages and the attachments are displayed as notifications on the communications device 110.

In exemplary embodiments, the subscriber is provisioned a primary email account. The email account is associated with the telephone number of the IPTV subscriber's primary household telephone number (e.g., the local part of the subscriber's email address can comprise the primary household telephone number). The primary email account is configured to auto-forward all received email messages to a secondary email account that can be serviced by an email server. After being forwarded to the secondary email account, the email message can be configured to be deleted from the sending primary email account.

At predetermined time intervals, the back-end 146 periodically polls the email server to ascertain if the email server has received any new email messages. The back end 146 can include a POP3 reader thread, which is configured to periodically read a POP3 mailbox that has been configured to receive IPTV email messages. The back-end 146 can retrieve new email messages from the email server. For each retrieved email message, the back-end 146 saves the text of the email message, and if attached, the first image file attachment to an email log. The IPTV gateway 145 can transmit a notification to the subscriber location 105 that an email message has been received. The IPTV gateway 145 stores the received email message information, thus allowing the IPTV subscriber to retrieve the email message information at a later time period with the use of the message center application. As described herein, messages and notifications can be implemented for a variety of purposes related to the remote DVR management and scheduling services described herein. For example, notifications can be sent to the subscriber household related to scheduling in which the subscriber may be interested, scheduling conflicts within the subscriber's recording schedule, and capacity issues with the DVR 120, as further described herein.

In exemplary embodiments, the IPTV gateway 145 may implement authentication using a high-speed processing device (e.g., a computer system) that is capable of handling high volume activities conducted via communications devices, and other network entities (e.g., parts of the IPTV infrastructure 140, network 135, etc.) via one or more networks (e.g., the IPTV infrastructure 140). The IPTV gateway 145 receives requests from one or more devices from the subscriber location 105 to access network services, such as the remote DVR management and scheduling services. The IPTV gateway 145 may implement authentication software for restricting or controlling access to network. The IPTV gateway 145 may be in communication with a customer identity system (CIS) database, which stores subscriber credentials (e.g., subscriber names and passwords) established via the remote DVR management and scheduling services account.

In exemplary embodiments, the system 100 can further include the remote DVR management and scheduling services application 155 that can reside on the IPTV gateway 145, as mentioned above. In exemplary embodiments, the remote DVR management and scheduling services application 155 can be implemented by the subscriber to access and set up an interface application 156 to implement remote DVR management and scheduling services application 155. The interface application 156 can be implemented to locally or remotely search for and schedule programs on the DVR 120. The interface application 156 can further be implemented to access account information from the IPTV gateway 145 and the preferences server 150. The interface application 156 can further be implemented to manage cancellation and deletion of programs, search saving and favorite channel management. In exemplary embodiments, the remote DVR management and scheduling services application 155 can include pointers to the content services provider server 160 for accessing scheduling information and for directing content to be recorded on the DVR 120. The pointers, in turn, provide access to the schedules stored in the database 165 for streaming to the subscriber's set top box 115 for rendering on the interface application 156. The interface application 156 is shown as residing on the IPTV gateway 145. It is appreciated that the interface application 156 can reside on the set top box 115 and on the remote device 117. In further embodiments, the interface application 156 can reside partially on the IPTV gateway 145 and partially on the set top box 115 and partially on the remote device 117. As further described below, the interface application 156 be implemented to store scheduling and recording data such that a subscriber can access the data via an interface displayed on a device such as the communications device 110 and the remote device 117.

In exemplary embodiments, the interface application 156 also provides access to the IPTV gateway 145, such that messages and notifications can be passed between the subscriber location 105 and the IPTV gateway 145 that include present scheduling and historic scheduling that the subscriber has been created in the past. Furthermore, if any changes in the subscribers scheduled videos have occurred, messages can be passed to the subscriber location 105 (or the remote device 117) to notify the subscriber that a program scheduled to be viewed has changed. The subscriber can make changes accordingly.

In exemplary embodiments, as discussed above, the system 100 further includes the content services provider server 160, which is in communication with the IPTV gateway 145 via the network 135. In exemplary embodiments, the content services provider server 160 is implemented by a host system (e.g., a high-speed processing device) that provides content to its subscribers (e.g., a subscriber of the communications device 110), such as television programs, premium programming services, video on demand content, and Internet/Web content (e.g., podcasts, and streaming media). In exemplary embodiments, the content is transmitted to the subscribers (e.g., at subscriber location 105) via a broadband connection over an Internet Protocol (IP)-based network (e.g., network 135). The content services provider server 160 can also provide an onscreen programming guide (e.g., EPG) to customers (e.g., the subscriber of program receiving device 150) that provides information about current and future programming available via the content providers' services. Programming information provided by the onscreen programming guide may include current and future program listings including program titles, primary actors/actresses, begin time, duration of program, a year in which the program was produced, and a brief text description of the program.

In exemplary embodiments, the content services provider server 160 is coupled to the database 165. In a one implementation, the database 165 may be representative of a given play list. A play list is associated with a particular program screen. For example, a play list can be generated for a given screen that is displayed for a view on the communications device 110. As a subscriber is browsing through different channels, and therefore different program content, as each new channel and program content are displayed on the communications device 110, a different play list is accessed by the communications device 110 from the content services provider server 160, which can be via set top box 115. In exemplary embodiments, play lists can include programming content, as well as programming schedules for the content (e.g., onscreen programming guide information (EPG)). In exemplary embodiments, the database 165 stores records of programming events scheduled for transmission to customers, such as communications device. These records, in turn, can be used in conjunction with the DVR 120 in order to schedule recordings.

In exemplary embodiments, upon a request from the subscriber location 105, the IPTV gateway 145 can coordinate obtaining the acquired data from the database 165 and provide the acquired data for display and rendering at the subscriber location 105. It is appreciated that the coordination of acquiring the data and ultimately displaying the data on the communications device 110 (or other device) is implemented via the DVR management and scheduling services application 155.

In exemplary embodiments, upon a request from the subscriber location 105, the IPTV gateway 145 can coordinate obtaining the video from the database 165 and provide the acquired data (e.g., playlists and selected videos) for display and rendering at the subscriber location 105. As described, the coordination of acquiring the data and ultimately displaying the data on the communications device 110 (or other device) is implemented via the remote DVR management and scheduling services application 155. Furthermore, the DVR management and scheduling services application 155 coordinates the transfer of the program data from the database 165 for rendering on the communications device 110.

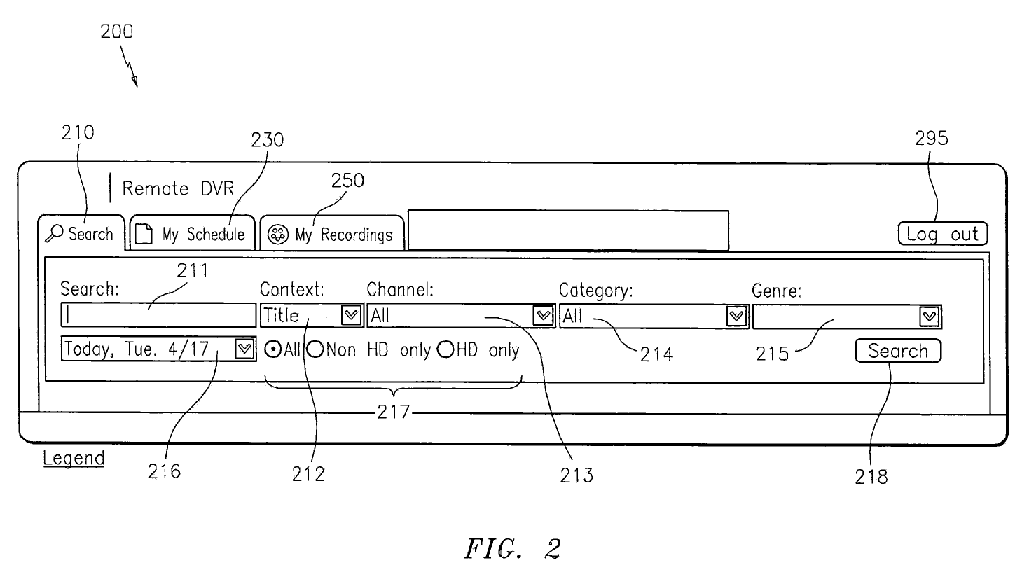

As described herein, the system 100 includes a remote DVR management and scheduling services interface application 156 to implement the DVR management and scheduling services. FIG. 2 illustrates a screen shot of an exemplary DVR search user interface 200 that can be displayed on a suitable device (e.g., the communications device 110). In exemplary embodiments, the interface 200 can include multiple tabs 210, 230, 250 that can be implemented to navigate a subscriber to multiple screens for a multiplicity of DVR management and scheduling services from a remote location. A search tab 210 provides an interface in which the subscriber can search for programs to record on the DVR 120. A schedule tab 230 provides an interface in which the subscriber can implement DVR schedule options. A recordings tab 250 provides an interface in which the subscriber can manage recordings that have already been made. An. The interface 200 further includes a logout button 295 so that the subscriber can navigate from the interface 200 when complete.

Referring still to FIG. 2, the interface 200 illustrates multiple search option capabilities. In exemplary embodiments, the interface 200 includes a free-form search field 211, in which the subscriber can enter search terms. In exemplary embodiments, the interface 200 includes a context field 212, in which the subscriber can enter a specific context via a pull-down menu, for example. The context field 212 can include title, actor, director or other suitable contexts. As such, it is appreciated that the subscriber can significantly narrow down the search data that is returned to the interface 200. The interface 200 can further include a channel field 213, in which the subscriber can search by channels only. The interface 200 can also include a category field 214 to further narrow the search. The category field 213 can include a pull-down menu to display categories of programs to be searched such as but not limited to movies, documentaries, news, musicals and sitcoms. The interface 200 can further include a genre field 215 that can include a pull-down menu to display various genre categories including but not limited to drama, comedy and science fiction. In exemplary embodiments, the subscriber can search by date. As such, the interface 200 can further include a date field 216. In exemplary embodiments, the search criteria can also be limited by whether or not the programs associated with the search data are high-definition (HD) or non-HD. Therefore, the interface 200 can further include a data field 217 in which the subscriber can specify whether to return HD, non-HD or both HD and non-HD (e.g., All). Once the subscriber has selected the desired search criteria, the subscriber can press a search button 218 to have data returned to the interface 200. In exemplary embodiments, the search request is sent to the content services provider server 160 via the IPTV gateway 145 and data is returned to the subscriber location 105 from the database 165.

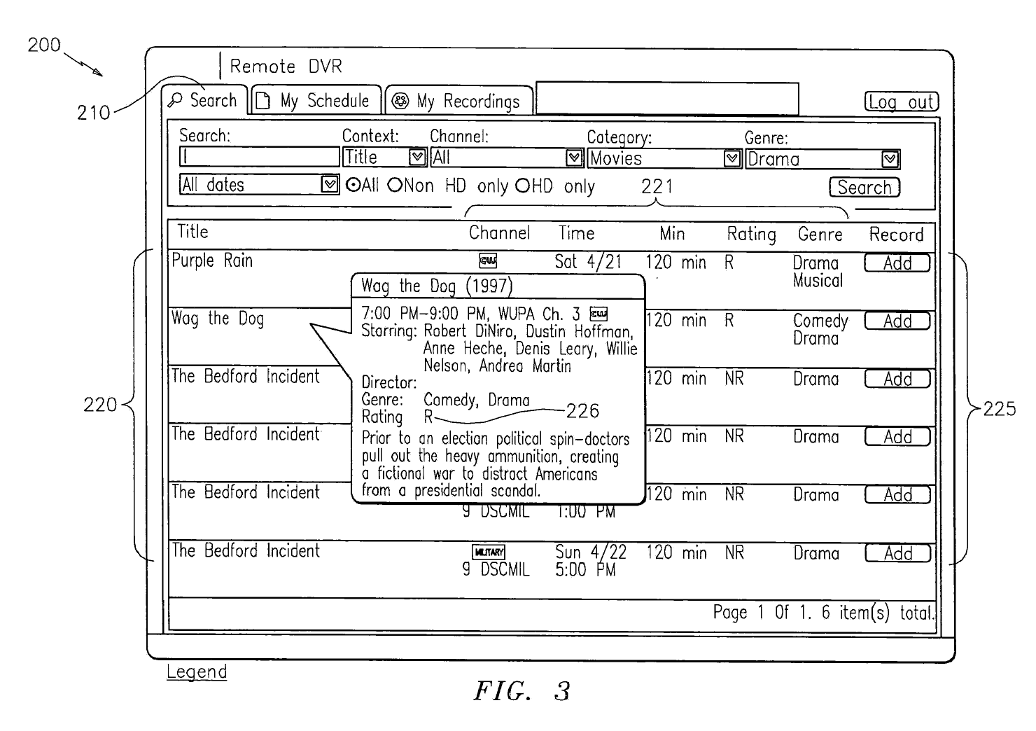

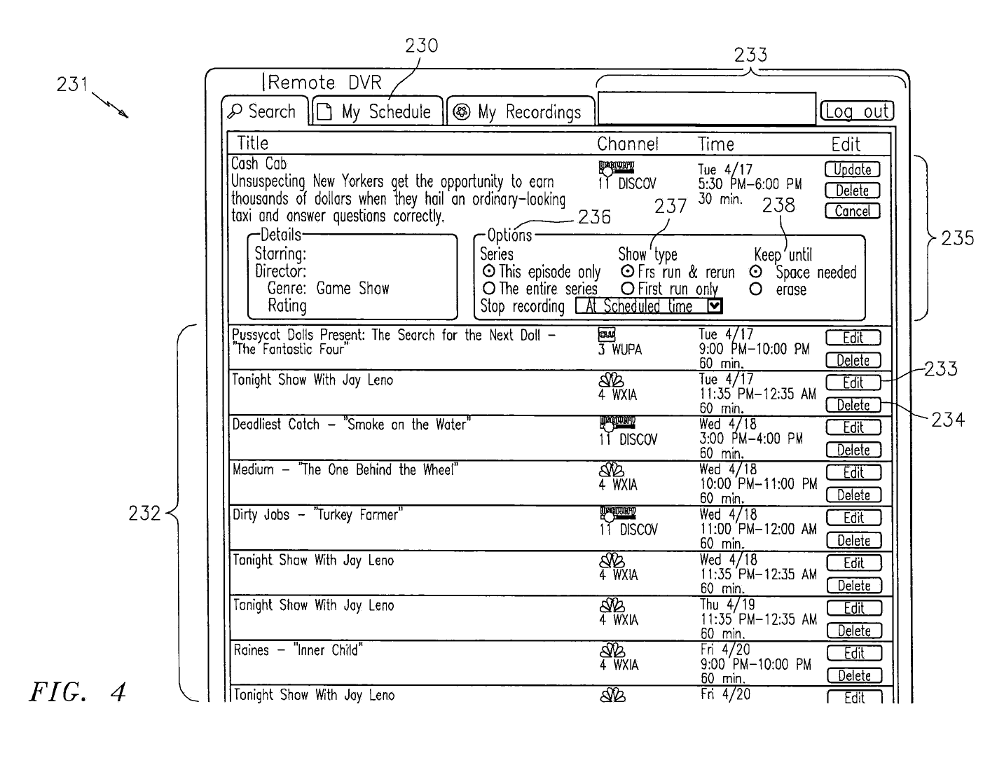

FIG. 3 illustrates another screen shot of a DVR search user interface 201 in accordance with exemplary embodiments. Once the subscriber has entered the desired criteria and pressed the search button 218 as described above, the data is returned to the interface 201. In this example, the subscriber as entered data for a “movies” category with a “drama” genre. The data that is returned includes a listing of movies 220 as well as a series of descriptive columns 221 having information including channel, time, running time, rating and genre. Furthermore, the interface includes “add” buttons 225 in which the subscriber can press to add to the recording schedule interface (see interface 231 in FIG. 4). In exemplary embodiments, the subscriber can view information about the program. For example, the subscriber can select one of the programs from the listing of movies 220, (e.g., via navigation tools unique to the remote device 117). When the listing is selected, an informational screen 226 can be displayed, which includes information about the selected program. In exemplary implementations, the informational screen 226 can be generated by a loading the program data using a program that does not interfere with the loading of the interface 200 (e.g., asynchronous javascipt and XML (AJAX)), suitably modified for the remote device 117.

In exemplary embodiments, in order to schedule a program for recording, the subscriber presses the add button 225 associated with the desired program. The program listings 220 display the earliest possible recording time to the subscriber, given currently scheduled programs and bandwidth. As discussed above, the system 100 recognizes specific category information such as genre. In exemplary embodiments, the subscriber can input pre-set category information into the systems (e.g., via the preferences server 150). For example, the subscriber can configure the interface 200 to record all “News” programs in SD while preserving bandwidth and storage required for HD for movies and preferred television series. In exemplary embodiments, the subscriber can therefore store preferences based on preferences such as but not limited to favorite categories, or category specifics, favorite channels, and specific search criteria.

In exemplary embodiments, when the subscriber selects a program of interest (e.g., from the EPG), the system 100 (e.g., via the content services provider server 160) presents a list of potential recording times for the program. FIG. 3 illustrates, for example, four possible recording times for “The Bedford Incident”. As discussed above, the list can be presented based on the subscriber's preferences (e.g., display only HD times for movies). The system 100 therefore searches for all titles in the returned data. The system 100 further checks to ascertain whether or not there is a scheduling conflict. If there is no conflict, then the program is schedule, which includes matching the media format with the genre preferences established by the subscriber, and ensuring that bandwidth requirements are met. Once the program is scheduled, then any data returned by the system 100 in future searches reflects the current schedule. In exemplary embodiments, existing scheduled programs are refreshed ensuring that any changes to existing programs is reflected.

If there is a scheduling conflict with the currently scheduled program to be recorded. Then the system provides conflict resolution. In exemplary embodiments, the subscriber is notified of a conflict that may arise when schedules of such programs change (e.g., via messages and notifications as described herein). In exemplary embodiments, the system 100 displays an alert on the television screen letting the subscriber know that there is a recording conflict that has arisen e.g., a current movie programming request conflicts with an ongoing series recording), and gives the subscriber the option to resolve the conflict (e.g., record one show in favor of another in case of conflict). The resolution alert/dialog may appear when the interactive program data information first changes, or it may be displayed as soon as the user accesses the system 100. The alert/dialog may appear periodically if the user has yet to respond to the conflict.

In exemplary embodiments, if there is a scheduling conflict, a prioritized list is presented based on the subscriber profile including, but not limited to: media format that matches genre preferences listed in the subscriber preferences; bandwidth limitations during the recording time; and re-ordering options to accommodate the desired recording. In exemplary embodiments, if it is not possible to record a particular program based on the current schedule, previously scheduled programs are removed to offer a schedule that successfully captures all programs in the earliest possible order. In exemplary embodiments, if it is not possible to reschedule a program to resolve the conflict, then the system 100 provides options that require the removal of an existing program in favor of the new desired program.

As discussed herein, the subscriber can receive requested programming data. In exemplary embodiments, all daily data can be provided from the content services provider server 160 to a device accessible by the subscriber (e.g., the IPTV gateway 145). In turn, each time the subscriber performs a search based on the daily data, the searched data can be stored in a local cache, such as in the cache 121. Once received, the subscriber can sort and schedule based on this stored data daily and on a search-by-search basis. For example, once the data is cached, it is readily available for search modifications based on different criteria. As such, the subscriber can sort the cached data by channel, by genre or any of the other categories in the descriptive columns 221 as described above. In exemplary embodiments, the searchable daily data can be pre-indexed XML data stored in a structured query language (SQL) database in the local cache 121. In exemplary embodiments, the DVR management and scheduling application 155 can be a web-based application having a browser. As such, it is appreciated that the device onto which the subscriber displays the interface 200 (e.g., the communications device 110, the device 117 and the subscriber computer 125) can be a device that is capable of supporting a web browser to search the daily data from the cache 121.

Furthermore, as described above, scheduling data is maintained by the content services provider server 160 on a periodic basis, which is longer than a single day (e.g., two weeks). It is appreciated that the periodic data can be cached on a daily basis as well as described above. In exemplary embodiments, once data has been cached, once the subscriber begins to type search criteria into a search field (e.g., the free form search field 211), partial matches are displayed in the search field, thereby enabling the subscriber to select from previously cached search criteria. In this way, it is appreciated that by organizing data in the cache 121, search content can be narrowed. In exemplary embodiments, the interface 200 can further include a “save search” feature in which the subscriber can save search criteria that the subscriber often enters.

As described above, the subscriber can add selected programs to the subscriber schedule using the add buttons 225, thereby generating a subscriber schedule that the subscriber can view, edit and manage as now described.

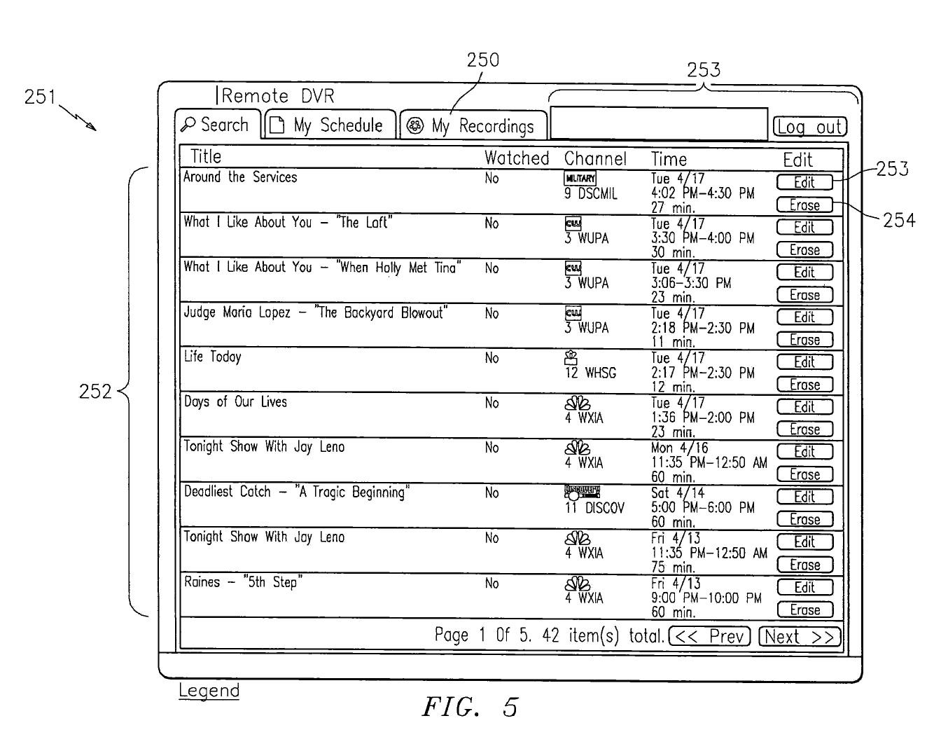

FIG. 4 illustrates a screen shot of a DVR schedule user interface 231 in accordance with exemplary embodiments. As described above, the interface 200 includes multiple tabs (that are present in each interface to which the subscriber navigates) including a schedule tab 230 that, when navigated, displays the schedule interface 231. In exemplary embodiments, the interface 231 can display a list of programs 232 that the subscriber has selected for recording on the DVR 120. The interface 231 can further include as a series of descriptive columns 233 having information including title, channel and time recorded/running time. The interface 231 can further include an edit button 233 for opening up a particular program listing for review and edit. The interface 231 can further include a delete button 234 to delete the program. As described above, the subscriber can select to edit a program by pressing the edit button 233. When the subscriber presses the edit button 233, the program listing associated with the pressed edit button 233, expands to a viewing field 235. The viewing field 235 can include information about the program such as description, actors, genre and other data. The viewing field can further include edit field options. In the example shown, a series has been recorded (and in the process of being recorded). The subscriber is given a series options field 236 into which the subscriber can select to record particular episodes or an entire series of the episodes, in which case the DVR 120 records each instance of the series as it occurs in the program listings provided by the content services provide server 160, for example. However, the subscriber also has the option to enter whether to record first runs or first runs and reruns in a show type options field 237. As such, the DVR 120 records the selected series but only dependent on whether it is a first run or a rerun. Furthermore, the subscriber has the option to keep the particular recordings dependent on a “keep until” options field 238. As such the subscriber can control whether or not certain programs are deleted. For example, the subscriber can elect never to erase a program until the subscriber has manually erased the program. However, the subscriber can elect to flag a particular program (or groups of programs such as an entire series) to be automatically deleted in space is need on the DVR 120 to record other programs. For example, if the DVR 120 is scheduled to record a new movie, but does not have the capacity to record the movie, the DVR 120 automatically deletes a program that has an associated “keep until” data field option that has been selected to be erased if space is needed for a new recording. In exemplary embodiments, the “keep until” field can further include a time limit field into which the subscriber can enter a time period after which the program is erased (for example, once space is needed or alternatively to be automatically erased after the selected time period). In further exemplary embodiments, additional fields can be selected to create a deletion or cancellation priority as further described with respect to FIG. 5. In exemplary embodiments, the interface 213 can further include a recording time field 239. In this way, the subscriber can choose to start and stop recording at the scheduled time or at a different time such as a specified number of minutes later. In this way, the subscriber can add time at the beginning and at the end of the recording to have a “pad” to ensure that the full program is recorded, for example, in the case of a delayed start.

FIG. 5 illustrates a screen shot of a DVR recordings user interface 251 in accordance with exemplary embodiments. As described above, the interface 200 includes multiple tabs (that are present in each interface to which the subscriber navigates) including a recordings tab 250 that, when navigated, displays the recordings interface 251. In exemplary embodiments, the interface 251 can display a list of programs 252 that the subscriber has recorded (or in the process of recording (e.g., an ongoing recording of a series) on the DVR 120. The interface 251 can further include as a series of descriptive columns 253 having information including title, channel and time recorded/running time. In exemplary embodiments, the interface 251 can include an indication of whether or not a program has been viewed. For example, the descriptive columns can include a “watched” indication, with a respective “YES” and “NO” next to a respective program. In exemplary embodiments, the list of programs 252 recorded onto the DVR 120 are displayed with the indication, which may be the “YES” and “NO” as described above, or a flag or any other type of indicator, of whether the program has been watched. In exemplary embodiments, the data field associated with the program is set to “watched” (e.g., “YES”) once the recorded program has been played from start to finish.

Referring still to FIG. 5, the interface 251 can further include an edit button 253 for opening up a particular program listing for review and edit. The interface 251 can further include an erase button 254 to delete the program from the recordings interface 251. As described above, the subscriber can select to edit a program by pressing the edit button 253. When the subscriber presses the edit button 253, the program listing associated with the pressed edit button 253, expands to a viewing field similar to the viewing field as described with respect to FIG.4. The viewing field can include information about the program such as description, actors, genre and other data. The viewing field can further include edit field options. The edit field options provides the subscriber with edit options such as managing ongoing series recording as described above. Furthermore, in exemplary embodiments, when the subscriber highlights a particular program, a informational screen similar to the informational screen 226 as illustrated in FIG. 3 can be displayed, which includes information about the selected program. In exemplary implementations, the information screen can be generated by a loading the program data using a program that does not interfere with the loading of the interface 251 (e.g., asynchronous javascipt and XML (AJAX)).

In exemplary embodiments, the subscriber can implement cancellation options and deletion priority options for the programs that have been viewed. As described above, in exemplary embodiments, the list of programs 252 recorded onto the DVR 120 are displayed with an indication, which may be a flag or any other type of indicator, of whether the program has been watched. In exemplary embodiments, a subscriber may schedule multiple recordings of the same program to be made to ensure that at least one recording of the desired program is successful. In exemplary embodiments, if a recorded program has been watched or viewed, future scheduled recordings of the same program (even if on a different channel) can be cancelled. In exemplary embodiments, the subscriber may customize the DVR options so that the default is to cancel such future recordings, such as via the preferences server. In exemplary embodiments, the subscriber may also be prompted after the user has finished watching the recorded program. For example, a notification can be displayed on the communications device 110 (or other device in which the recorded program is viewed). The DVR management and scheduling application 155 may search for all scheduled future recordings of the program the user has just watched, bring up a list of such programs, and provide a way for the user to cancel the future recordings (prompting, check-box, other selection methods). For example, all scheduled recordings can be displayed on the recordings interface 251 with a corresponding edit button 253 and erase button 254. As such, only those recordings that are subject to the cancellation options are displayed on the recordings interface 251. In exemplary embodiments, the subscriber may be prompted to cancel future recordings of the already watched program at or near the time in which the future recording is scheduled to be recorded. There may be an indication to the user that the program that is about to be recorded has already been viewed by the user, and the user may be presented with the option to continue to record or to cancel the recording.

With regard to deletion priority, as described above, In exemplary embodiments, the list of programs recorded onto the DVR 120 are displayed with the “watched” indication, which may be a flag or any other type of indicator, of whether the program has been watched. The data field associated with the program is set to “watched” once the recorded program has been played from start to finish. In exemplary embodiments, the setting of the field can be used to alter the priority of deletion of stored programs. In exemplary embodiments, the subscriber has the option keep programs on the DVR 120 until space is needed. When space is needed, such designated programs can be deleted based on the date they were recorded (i.e., first in, first out). In exemplary embodiments, if a recorded program that is scheduled for deletion when space is needed has been watched, it is deleted before a program scheduled for deletion when space is needed that has not been watched, regardless of the date on which the programs are recorded. In exemplary embodiments, if two programs scheduled for deletion when space is needed have both been watched, then the system reverts back to deleting the one that has been recorded first (i.e., first in, first out). As described above, the subscriber can also edit a particular program to only be erased when the subscriber manually erases the program. As such, if there is a program that the subscriber wants to keep indefinitely, the subscriber can ensure that it is not erased even if space is needed. In exemplary embodiments, the subscriber can provision additional disk space if needed as described above.

In exemplary embodiments, it is appreciated that the subscriber location may have multiple people who have different preferences set up for their respective accounts. It is further appreciated that the accounts can be linked. Since there may only be one DVR in the subscriber location, such as the DVR 120, the different account information can be compiled such that conflict resolution for multiple schedules in the subscriber location can be implemented across the accounts. Similarly, DVR capacity can also be calculated based on the multiple schedules in the subscriber location. Therefore, for deletion priority and cancellation options, it is appreciated that multiple users in the household may have recorded the same program, but only one may have actually viewed the program. Therefore, the deletion priority can be based further on sending a notification to all users of the subscriber location 105 who have either scheduled and/or recorded the same program. Therefore, deletion does not occur unless all users who have either scheduled and/or recorded the program have acknowledged that they have viewed it and agree that it is permissible to delete the program. Alternatively, the system 100 can track all users over multiple accounts to ensure that the multiple users have actually viewed the program before the program is deleted. It is therefore appreciated that the systems and methods described herein can be implemented across multiple users that are linked to a common account. It is further appreciated that any one of the users at the subscriber location 105 can used a respective remote device (e.g., the remote device 117) in order to access their specific account information.

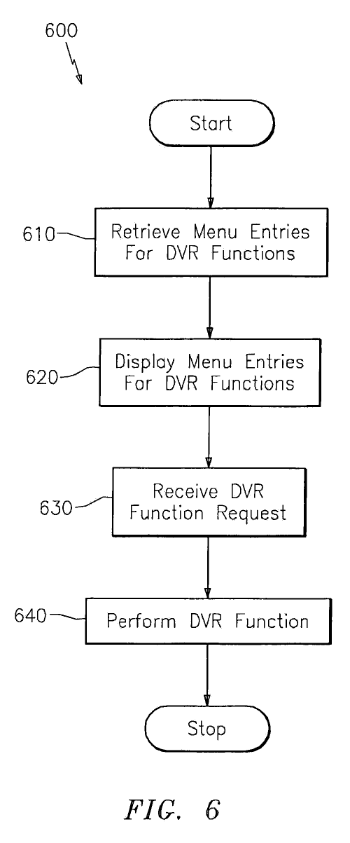

FIG. 6 illustrates a flow chart of a remote DVR management and scheduling method 600 in accordance with exemplary embodiments. At block 610, the remote DVR management and scheduling application 155 retrieves a set of menu entries for a menu displayed on the subscriber's remote device 117, each of the menu entries representing a digital video recorder function. At block 630, the remote DVR management and scheduling application 155 displays the set of menu entries on the display of the remote device 117. At block 630, the remote DVR management and scheduling application 155 receives a request from the subscriber to perform one of the functions from the remote device 117. At block 640, the remote DVR management and scheduling application 155 performs the selected function. In this way, the subscriber can control the DVR 120 from a remote location. For example, if the subscriber is traveling and remembers that the subscriber wants to record a particular program, the subscriber can use the remote device 117 to send a recording request to the DVR 120.

In exemplary embodiments, as described above, the remote DVR management and scheduling application 155 can further display data fields adjacent each menu entry indicating an option to search for a program to be recorded, retrieve programming data based on the search criteria and displaying the programming data on the display. In exemplary embodiments, the remote DVR management and scheduling application 155 can further display data fields adjacent a respective program in the programming data, the data fields configured to add the program to a recording schedule. Furthermore, the remote DVR management and scheduling application 155 can add the selected program to the recording schedule.

In further exemplary embodiments, the remote DVR management and scheduling application 155 can retrieve meta-data related to a respective program in the programming data, translate the meta-data for display within an informational screen and display the meta-data within the informational screen on the display. In exemplary embodiments, the remote DVR management and scheduling application 155 can further display a recording schedule on the display, the recording schedule having a listing of programs to be recorded on a digital video recorder coupled to the Internet Protocol enabled device, display edit and delete data fields adjacent each program in the listing of programs and update the recording schedule data based on the search criteria.

In exemplary embodiments, the remote DVR management and scheduling application 155 can display expanded edit data fields adjacent each program in the listing of programs. The expanded data fields can include a data field configured to be populated with data indicating a series recording, a data field configured to be populated with data indicating a show type including at least one of first run and re-run, a data field configured to be populated with data related to deletion priority of a respective program and a data field configured to be populated with data related to a scheduled start time of the program and recording time after a scheduled ending of the program.

In further exemplary embodiments, the remote DVR management and scheduling application 155 can display a listing of programs that have been recorded on the DVR 120, display edit and erase data fields adjacent each program in the listing of programs and update the listing of programs that have been recorded on the DVR 120.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. In a remote device for accessing an Internet Protocol-enabled device communications system, the remote device having a graphical user interface including a display and a selection device, a method of providing and selecting from a menu on the display, the method comprising:
retrieving a set of menu entries for the menu, each of the menu entries representing a digital video recorder function;
displaying the set of menu entries on the display;
receiving a menu entry selection signal indicative of the selection device pointing at a selected menu entry from the set of menu entries; and
in response to the signal, performing an associated digital video recorder function.

2. The method as claimed in claim 1 further comprising:
displaying data fields adjacent each menu entry indicating an option to search for a program to be recorded;
receiving a selection signal indicative of a selection device pointing at selected data fields that have been populated with search criteria;
in response to the selection signal, retrieving programming data based on the search criteria; and
displaying the programming data on the display.

3. The method as claimed in claim 2 further comprising:
displaying data fields adjacent a respective program in the programming data, the data fields configured to add the program to a recording schedule;
receiving a selection signal indicative of a selection device pointing at selected data fields to add the program to the recording schedule; and
in response to the selection signal, adding the selected program to the recording schedule.

4. The method as claimed in claim 2 further comprising:
retrieving meta-data related to a respective program in the programming data;
translating the meta-data for display within an informational screen; and
displaying the meta-data within the informational screen on the display.

5. The method as claimed in claim 1 further comprising:
displaying a recording schedule on the display, the recording schedule having a listing of programs to be recorded on a digital video recorder coupled to the Internet Protocol enabled device;
displaying edit and delete data fields adjacent each program in the listing of programs;
receiving a selection signal indicative of a selection device pointing at selected data fields that have been populated with search criteria; and
in response to the selection signal, updating the recording schedule data based on the search criteria.

6. The method as claimed in claim 5 further comprising displaying expanded edit data fields adjacent each program in the listing of programs, the expanded data fields including at least one of a data field configured to be populated with data indicating a series recording, a data field configured to be populated with data indicating a show type including at least one of first run and re-run, a data field configured to be populated with data related to deletion priority of a respective program and a data field configured to be populated with data related to a scheduled start time of the program and recording time after a scheduled ending of the program.

7. The method as claimed in claim 1 further comprising:
displaying on the display a listing of programs that have been recorded on a digital video recorder coupled to the Internet Protocol enabled device, the recording schedule having a listing of programs to be recorded;
displaying edit and erase data fields adjacent each program in the listing of programs;
receiving a selection signal indicative of a selection device pointing at selected data fields to perform at least one of editing and erasing the respective program; and
in response to the selection signal, updating the listing of programs that have been recorded on the digital video recorder.

8. A system for displaying digital video recorder options on a remote device coupled to an Internet Protocol-enabled device, the remote device having a graphical user interface including a display and a selection device, the system comprising:
a digital video recorder coupled to the Internet Protocol-enabled device and in communication with the remote device;
a process for displaying digital video recorder options on the remote device, the process having instructions to:
retrieve a set of menu entries for a menu on the display, each of the menu entries representing a digital video recorder function,
display the set of menu entries on the display,
receive a menu entry selection signal indicative of the selection device pointing at a selected menu entry from the set of menu entries, and
in response to the signal, perform an associated digital video recorder function.

9. The system as claimed in claim 8 wherein the process further has instructions to:
display data fields adjacent each menu entry indicating an option to search for a program to be recorded;
receive a selection signal indicative of a selection device pointing at selected data fields that have been populated with search criteria;
in response to the selection signal, retrieve programming data based on the search criteria; and
display the programming data on the display.

10. The system as claimed in claim 9 wherein the process further has instructions to:
display data fields adjacent a respective program in the programming data, the data fields configured to add the program to a recording schedule;
receive a selection signal indicative of a selection device pointing at selected data fields to add the program to the recording schedule; and
in response to the selection signal, add the selected program to the recording schedule.

11. The system as claimed in claim 9 wherein the process further has instructions to:
retrieve meta-data related to a respective program in the programming data;
translate the meta-data for display within an informational screen; and
display the meta-data within the informational screen on the display.

12. The system as claimed in claim 8 wherein the process further has instructions to:
display a recording schedule on the display, the recording schedule having a listing of programs to be recorded on the digital video recorder;
display edit and delete data fields adjacent each program in the listing of programs;
receive a selection signal indicative of a selection device pointing at selected data fields that have been populated with search criteria; and
in response to the selection signal, update the recording schedule data based on the search criteria.

13. The system as claimed in claim 12 wherein the process further has instructions to display expanded edit data fields adjacent each program in the listing of programs, the expanded data fields including at least one of a data field configured to be populated with data indicating a series recording, a data field configured to be populated with data indicating a show type including at least one of first run and re-run, a data field configured to be populated with data related to deletion priority of a respective program and a data field configured to be populated with data related to a scheduled start time of the program and recording time after a scheduled ending of the program.

14. The system as claimed in claim 8 wherein the process further has instructions to:
display on the display a listing of programs that have been recorded on a digital video recorder coupled to the Internet Protocol enabled device, the recording schedule having a listing of programs to be recorded;
display edit and erase data fields adjacent each program in the listing of programs;
receive a selection signal indicative of a selection device pointing at selected data fields to perform at least one of editing and erasing the respective program; and
in response to the selection signal, update the listing of programs that have been recorded on the digital video recorder.

15. A computer program product for displaying digital video recorder options on a remote device coupled to an Internet Protocol-enabled device, the remote device having a graphical user interface including a display and a selection device, the computer program product including instructions for causing a computer to implement a method, the method comprising:
retrieving a set of menu entries for the menu, each of the menu entries representing a digital video recorder function;
displaying the set of menu entries on the display;
receiving a menu entry selection signal indicative of the selection device pointing at a selected menu entry from the set of menu entries; and
in response to the signal, performing an associated digital video recorder function.

16. The computer program product as claimed in claim 15 wherein the method further comprises:
displaying data fields adjacent each menu entry indicating an option to search for a program to be recorded;
receiving a selection signal indicative of a selection device pointing at selected data fields that have been populated with search criteria; and
in response to the selection signal, retrieving programming data based on the search criteria; and
displaying the programming data on the display.

17. The computer program product as claimed in claim 16 wherein the method further comprises:
displaying data fields adjacent a respective program in the programming data, the data fields configured to add the program to a recording schedule;
receiving a selection signal indicative of a selection device pointing at selected data fields to add the program to the recording schedule; and
in response to the selection signal, adding the selected program to the recording schedule.

18. The computer program product as claimed in claim 16 wherein the method further comprises:
retrieving meta-data related to a respective program in the programming data;
translating the meta-data for display within an informational screen; and
displaying the meta-data within the informational screen on the display.

19. The computer program product as claimed in claim 15 wherein the method further comprises:
displaying a recording schedule on the display, the recording schedule having a listing of programs to be recorded on a digital video recorder coupled to the Internet Protocol enabled device;
displaying edit and delete data fields adjacent each program in the listing of programs;
receiving a selection signal indicative of a selection device pointing at selected data fields that have been populated with search criteria; and
in response to the selection signal, updating the recording schedule data based on the search criteria.

20. The computer program product as claimed in claim 19 wherein the method further comprises displaying expanded edit data fields adjacent each program in the listing of programs, the expanded data fields including at least one of a data field configured to be populated with data indicating a series recording, a data field configured to be populated with data indicating a show type including at least one of first run and re-run, a data field configured to be populated with data related to deletion priority of a respective program and a data field configured to be populated with data related to a scheduled start time of the program and recording time after a scheduled ending of the program.
